(19) United States
(12) Patent Application Publication
(10) Pub. No.: US 2021/0110340 A1
(43) Pub. Date: Apr. 15, 2021

(54) INFORMATION PROCESSING APPARATUS, INFORMATION PROCESSING SYSTEM, AND NON- TRANSITORY COMPUTER READABLE MEDIUM

(71) Applicant: TOYOTA JIDOSHA KABUSHIKI KAISHA, Toyota-shi (JP)

(72) Inventors: Ryuichi KAMAGA, Nisshin-shi (JP); Kouki MORIYA, Nagakute-shi (JP); Yui OGURA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 17/028,412

(22) Filed: Sep. 22, 2020

(30) Foreign Application Priority Data
Oct. 15, 2019 (JP) 2019-188924

(51) Int. Cl. G06Q 10/08; G06Q 10/00; G09B 15/00; G06Q 50/30; G01C 21/34

(52) U.S. Cl. CPC G06Q 10/0832; G06Q 10/20; G01C 21/343; G06Q 50/30; G09B 15/00

(57) ABSTRACT

An information processing apparatus includes a controller. The controller acquires holding information on a music class to be held in a vehicle and maintenance information on a maintenance person who performs maintenance on a music supply to be used in the music class, executes matching between the music class and the maintenance person based on the holding information and the maintenance information that are acquired, and determines notification information to be notified to the maintenance person, according to a result of the matching.

### CROSS-REFERENCE TO RELATED APPLICATION

This application claims priority to Japanese Patent Application No. 2019-188924, filed on Oct. 15, 2019, the entire contents of which are incorporated herein by reference.

### TECHNICAL FIELD

The present disclosure relates to an information processing apparatus, an information processing system, and a program.

### BACKGROUND

Music classes held among an instructor and a student at a predetermined date and time, and in a vehicle stocked with music supplies including a musical instrument and a musical score, are known. For example, Patent Literature (PTL) 1 discloses a vehicle used for a mobile class, in the main body of which a space for playing a musical instrument is secured and formed, a musical instrument being installed in the space so that a musical instrument playing lesson using the installed musical instrument can be provided. In such a music class, for example, a music supply to be used in teaching music is held in the vehicle used for the mobile class.

### CITATION LIST

### Patent Literature

PTL 1: JP 2001-277932 A

### SUMMARY

Music supplies to be used in a music class as described above are required to receive maintenance periodically or at any appropriate timing, the maintenance including tuning, adjustment of the quality of the music supplies themselves, or the like. However, in the conventional music class, the location and the date and time at which the class is held are predetermined to some extent, thus largely limiting the maintenance date and time for a maintenance person to temporarily take custody of a music supply from the music class to perform maintenance on the music supply, together with the location at which the music supply is to be delivered and the location at which the music supply is to be collected. Accordingly, even if maintenance of a music supply to be used in a music class becomes necessary, a maintenance person who can perform maintenance on the music supply may not be found at that point. As described above, the potential for matching between the music class and the maintenance person is low, and thus an appropriate maintenance person has not been effectively introduced to a music class that requires maintenance of music supplies. In PTL 1, the matching between the music class and the maintenance person as described above is not considered.

It would be helpful to enable effective matching between a music class and a maintenance person.

An information processing apparatus according to an embodiment of the present disclosure includes a controller configured to:

acquire holding information on a music class to be held in a vehicle and maintenance information on a maintenance person who performs maintenance on a music supply to be used in the music class;

execute matching between the music class and the maintenance person based on the holding information and the maintenance information that are acquired; and

determine notification information to be notified to the maintenance person according to a result of the matching.

A program according to an embodiment of the present disclosure is configured to cause an information processing apparatus to execute operations, the operations including:

acquiring holding information on a music class to be held in a vehicle;

acquiring maintenance information on a maintenance person who performs maintenance on a music supply to be used in the music class;

executing matching between the music class and the maintenance person based on the holding information and the maintenance information that are acquired; and

determining notification information to be notified to the maintenance person according to a result of the matching.

A program according to an embodiment of the present disclosure is configured to cause a terminal apparatus of a maintenance person who performs maintenance on a music supply to be used in a music class, to execute operations, the operations including:

transmitting maintenance information on the maintenance person who performs maintenance on the music supply to be used in the music class to be held in a vehicle, to an information processing apparatus; and

receiving notification information determined by the information processing apparatus according to a result of matching between the music class and the maintenance person executed by the information processing apparatus based on holding information on the music class and the maintenance information that are acquired by the information processing apparatus.

An information processing apparatus, an information processing system, and a program according to an embodiment of the present disclosure enable effective matching between a music class and a maintenance person.

### BRIEF DESCRIPTION OF THE DRAWINGS

In the accompanying drawings:

FIG. 1 is a configuration diagram illustrating a configuration of an information processing system including an information processing apparatus according to an embodiment of the present disclosure;

FIG. 2 is a functional block diagram illustrating a schematic configuration of each of an information processing apparatus, a first terminal apparatus, and a second terminal apparatus in FIG. 1;

FIG. 3 is a first diagram for explaining matching between a music class and a maintenance person;

FIG. 4 is a second diagram for explaining matching between the music class and the maintenance person;

FIG. 5 is a flowchart for explaining a first example of an information processing method executed by the information processing apparatus in FIG. 1;

FIG. 6 is a flowchart for explaining a second example of the information processing method executed by the information processing apparatus in FIG. 1;

FIG. 7 is a flowchart for explaining a third example of the information processing method executed by the information processing apparatus in FIG. 1; and

FIG. 8 is a flowchart for explaining a fourth example of the information processing method executed by the information processing apparatus in FIG. 1.

### DETAILED DESCRIPTION

An embodiment of the present disclosure will be described below, with reference to the drawings.

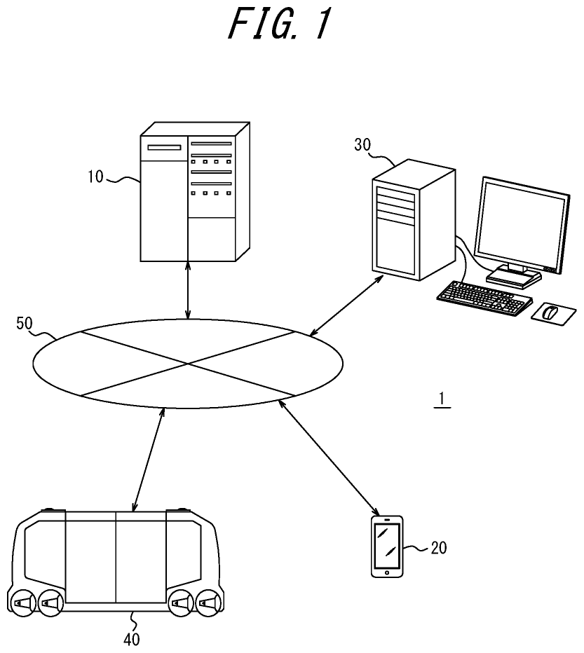

FIG. 1 is a configuration diagram illustrating a configuration of an information processing system 1 that includes an information processing apparatus 10 according to an embodiment of the present disclosure. Referring to FIG. 1, an outline of the information processing system 1 that includes the information processing apparatus 10 according to the embodiment of the present disclosure will be primarily described. In addition to the information processing apparatus 10, the information processing system 1 includes a first terminal apparatus 20 and a second terminal apparatus 30. For the sake of simplicity, FIG. 1 illustrates one of each of the first terminal apparatus 20, the second terminal apparatus 30, and a vehicle 40, but the number of first terminal apparatuses 20 and second terminal apparatuses 30 included in the information processing system 1, and vehicles 40 may be two or more.

Each of the information processing apparatus 10, the first terminal apparatus 20, and the second terminal apparatus 30 is connected to a network 50 that includes, for example, a mobile communication network, the Internet, and the like, together with the vehicle 40, in which a music class is held, so as to communicate with each other. At least part of the information processing system 1 is used for providing a mobility service. Each service provider can provide a mobility service such as a mobile music class, by using the vehicle 40. The number of instructors and students in a music class to be held in the vehicle 40 may be one, or may be two or more.

The information processing apparatus 10 is a single server apparatus or a plurality of server apparatuses that can communicate with each other. The information processing apparatus 10 is not limited to these, and may be any general purpose electronic device such as a personal computer (PC) or a smartphone, or may be any other electronic device that is dedicated to the information processing system 1.

The first terminal apparatus 20 is, for example, a general purpose electronic device such as a smartphone or a PC. The first terminal apparatus 20 is, for example, an electronic device used by a maintenance person who performs maintenance on a music supply to be used in the music class to be held in the vehicle 40. In this specification, the “music supply” includes, for example, a musical instrument or a musical score. The “maintenance” includes, for example, tuning or adjustment of the quality of a music supply itself. The “maintenance person” includes, for example, a maintenance staff member of a retailer selling music supplies, a maintenance staff member of a rental agent lending music supplies, or any other individual who specializes in maintenance of music supplies. The first terminal apparatus 20 is not limited to the above described electronic device, and may be a single server apparatus used by a retailer or a rental agent, or multiple server apparatuses used by a retailer or a rental agent that can communicate with each other, or may be an electronic device that is dedicated to the information processing system 1.

The second terminal apparatus 30 is, for example, a general purpose electronic device such as a PC or a smartphone. The second terminal apparatus 30 is, for example, an electronic device used by a member of staff of an operating company that operates the music class to be held in the vehicle 40. The second terminal apparatus 30 is not limited to these, and may be a single server apparatus used by the operating company, or a plurality of server apparatuses used by the operating company that can communicate with each other, or may be an electronic device that is dedicated to the information processing system 1.

The vehicle 40 is, for example, an automobile. The vehicle 40 is not limited to this, and may be any vehicle that a person can board to hold the music class in the vehicle 40. While the music class is held, the vehicle 40 may move, or may be stationary. The vehicle 40 is, for example, a vehicle that performs automated driving. The automated driving may include any level from Level 1 to Level 5 as defined by the Society of Automotive Engineers (SAE), for example, but is not limited to these, and may be defined in any way. The vehicle 40 is not limited to a vehicle that performs automated driving, and may be any vehicle driven by a driver.

The vehicle 40 delivers music supplies which are subject to maintenance to one or more maintenance persons who perform maintenance on music supplies to be used in the music class, and collects the music supplies, for which maintenance is complete, from the maintenance persons. For example, the vehicle 40 that is the same as the vehicle 40 in which a music class is to be held directly delivers/collects a music supply to be used in the music class to/from a maintenance person. Without being limited to this, one or more vehicles 40 that are different from the vehicle 40 in which the music class is to be held may indirectly deliver/collect music supplies to be used in the music class to/from a maintenance person, to cooperate with the vehicle 40 in which the music class is to be held. In this case, a corresponding type of the music supply to be delivered/collected by each vehicle 40 may be previously determined, or the vehicle 40 that is closest to the maintenance person among vehicles 40 that are dispersed in respective areas may deliver/collect the music supplies to/from the maintenance person.

As an outline of an embodiment, the information processing apparatus 10 acquires holding information on each music class to be held in the vehicle 40. In this specification, the “holding information” includes various information related to holding of a music class in the vehicle 40. The “holding information” includes, for example, a holding area, a start date and time, an end date and time, and details of a music supply to be used. The “details of a music supply” include, for example, the number of music supplies and the type of each music supply. In addition, the “details of a music supply” may include, for example, a usage period that has elapsed since previous maintenance, a total usage period, or a usage frequency.

The information processing apparatus 10 acquires maintenance information on a maintenance person who performs maintenance on a music supply to be used in a corresponding music class. In this specification, the “maintenance information” includes various information related to maintenance, by a maintenance person, of a music supply to be used in a music class to be held in the vehicle 40. The “maintenance information” includes, for example, a delivery location, a collection location, and a maintenance period that are desired by a maintenance person, and details of a music supply on which the maintenance person desires to perform maintenance.

The information processing apparatus 10 executes matching between a music class and a maintenance person based on the holding information and the maintenance information that are acquired, and determines notification information to be notified to the maintenance person according to the result of the matching. In this specification, “matching” means determining a certain music class and a certain maintenance person for which the holding information and the maintenance information conform to each other, from a plurality of music classes and a plurality of maintenance persons, respectively. The number of maintenance persons subject to matching against one music class may be one, or may be two or more. The “notification information” includes various information related to maintenance of a music supply to be used in a music class, the various information being required in order to have a maintenance person perform the maintenance. The “notification information” includes, for example, a delivery location, a delivery date and time, a collection location, a collection date and time, and details of a music supply, regarding maintenance of a music supply.

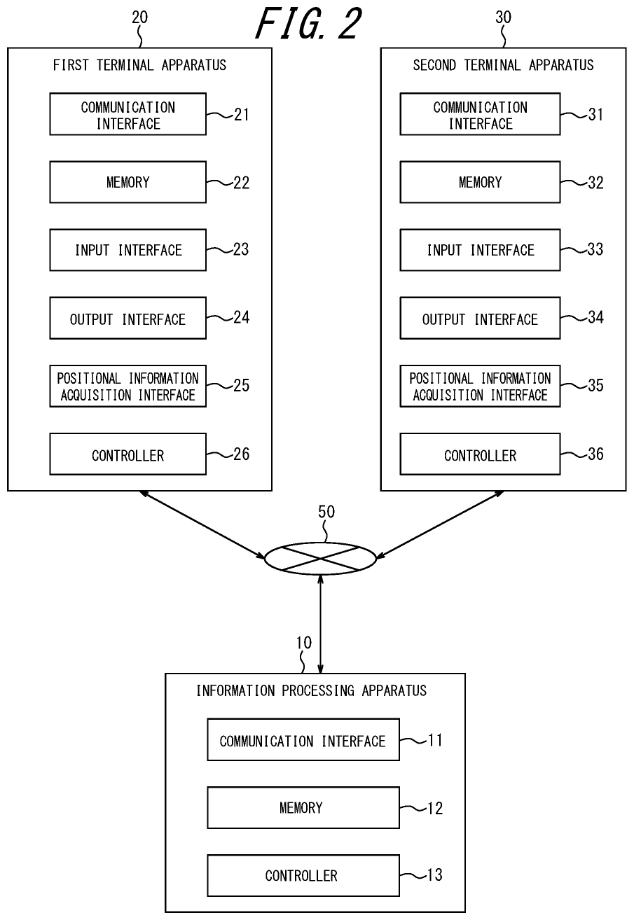

Next, referring to FIG. 2, a configuration of each apparatus included in the information processing system 1 will be primarily described. FIG. 2 is a functional block diagram illustrating a schematic configuration of each of the information processing apparatus 10, the first terminal apparatus 20, and the second terminal apparatus 30 in FIG. 1.

As illustrated in FIG. 2, the first terminal apparatus 20 includes a communication interface 21, a memory 22, an input interface 23, an output interface 24, a positional information acquisition interface 25, and a controller 26.

The communication interface 21 includes a communication module connected to the network 50. For example, the communication interface 21 may include a communication module compliant with mobile communication standards such as the 4th generation (4G) and the 5th generation (5G) standards. In an embodiment, the first terminal apparatus 20 is connected to the network 50 via the communication interface 21. The communication interface 21 transmits and receives various information via the network 50.

The memory 22 is, for example, a semi-conductor memory, a magnetic memory, an optical memory, or the like, but is not limited to these. The memory 22 may function as, for example, a main memory, an auxiliary memory, or a cache memory. The memory 22 stores any information used in operation of the first terminal apparatus 20. For example, the memory 22 may store a system program, an application program, various types of information received by the communication interface 21, and the like. Information stored in the memory 22 may be updated with, for example, information received from the network 50 via the communication interface 21.

The input interface 23 includes at least one input interface for detecting user input to acquire input information based on an operation by a user. The input interface 23 is, for example, a physical key, a capacitive key, a touch screen integrally provided with a display of the output interface 24, a microphone for receiving audio input, or the like, but is not limited to these.

The output interface 24 includes at least one output interface for outputting information to notify information to the user. The output interface 24 is, for example, a display for outputting the information in the form of an image, a speaker for outputting the information in the form of audio, or the like, but is not limited to these.

The positional information acquisition interface 25 includes at least one receiver compliant with a satellite positioning system. For example, the positional information acquisition interface 25 may include a Global Positioning System (GPS) receiver. The positional information acquisition interface 25 acquires a measured value of the position of the first terminal apparatus 20 as positional information. The positional information includes, for example, an address, a latitude, a longitude, and an altitude. The positional information acquisition interface 25 may continuously acquire, or may periodically or non-periodically acquire the positional information for the first terminal apparatus 20.

The controller 26 includes at least one processor. The “processor” is a general purpose processor or a dedicated processor that is dedicated to specific processing in an embodiment but is not limited to these. The controller 26 is connected to each component included in the first terminal apparatus 20 so as to communicate with each component, and controls operation of the entire first terminal apparatus 20.

When the input interface 23 detects an operation by the user as a maintenance person who requests registration of maintenance information, the controller 26 displays an input screen indicating items required for registration of the maintenance information, using the output interface 24. The items required for registration of the maintenance information include, for example, items of a delivery location, a collection location, and a maintenance period that are desired by the maintenance person, and details of a music supply on which the maintenance person desires to perform maintenance. The controller 26 acquires input information regarding these items that the user inputs by operating the input interface 23. The controller 26 transmits the acquired input information as the maintenance information to the information processing apparatus 10 via the communication interface 21 and the network 50.

The controller 26 receives, from the information processing apparatus 10 via the network 50 and the communication interface 21, notification information according to a result of the matching between a music class and a maintenance person executed by the information processing apparatus 10. The maintenance person understands the delivery location, the delivery date and time, the collection location, and the collection date and time regarding the music supply which is to be used in a music class and is to be subject to maintenance, and the details of the music supply, from the notification information notified by the first terminal apparatus 20. The maintenance person receives the music supply which is to be subject to maintenance, from the vehicle 40, which is navigated to the notified delivery location, at the delivery location at the notified delivery date and time. The maintenance person turns over the music supply, for which maintenance is complete, to the vehicle 40, which is navigated to the notified collection location, at the collection location and at the notified collection date and time.

For example, when the input interface 23 detects an operation by the user as a maintenance person who requests an evaluation of an instructor or a student in a music class, the controller 26 displays an input screen indicating items required for the evaluation of the instructor or the student, using the output interface 24. The items required for the evaluation include, for example, items of an evaluation target selected from among the instructor and the student, an evaluation index such as a rank and a score for the selected evaluation target, and an evaluation comment on the evaluation target. The controller 26 acquires input information regarding these items that the user inputs by operating the input interface 23. The controller 26 transmits the acquired input information as instructor evaluation information or student evaluation information indicating the result of the evaluation by the maintenance person of another from among the instructor and the student of the music class and the maintenance person, to the information processing apparatus 10 via the communication interface 21 and the network 50.

In this specification, the “evaluation information” includes, for example, an evaluation target, an evaluation index such as a rank and a score of the evaluation target, and an evaluation comment on the evaluation target. The term “student evaluation information” means evaluation information indicating a result of an evaluation of a student of a music class by an instructor of the music class or a maintenance person. For example, “student evaluation information” means evaluation information indicating a result of an evaluation of a student of a music class by an instructor of the music class regarding playing in the music class. For example, “student evaluation information” means evaluation information indicating a result of an evaluation, by a maintenance person, of the quality of an evaluation comment received from a student after the maintenance person checks the evaluation comment made by the student on the maintenance person.

The term “instructor evaluation information” means evaluation information indicating a result of an evaluation of an instructor of a music class by a student of the music class or a maintenance person. For example, “instructor evaluation information” means evaluation information indicating a result of an evaluation of an instructor of a music class by a student of the music class regarding playing instructions in the music class. For example, “instructor evaluation information” means evaluation information indicating a result of an evaluation, by a maintenance person, of the quality of an evaluation comment received from an instructor after the maintenance person checks the evaluation comment made by the instructor on the maintenance person.

The term “maintenance person evaluation information” means evaluation information indicating a result of an evaluation of a maintenance person by an instructor or a student of a music class. For example, “maintenance person evaluation information” means evaluation information indicating a result of an evaluation of a maintenance person, by an instructor or a student of a music class, regarding the quality of maintenance on a music supply performed by the maintenance person.

The controller 26 receives maintenance person evaluation information from the information processing apparatus 10 via the network 50 and the communication interface 21. When the input interface 23 detects an operation by the user of the maintenance person, the controller 26 outputs the received evaluation information to the output interface 24.

Next, the configuration of the second terminal apparatus 30 included in the information processing system 1 will be primarily described. As illustrated in FIG. 2, the second terminal apparatus 30 includes a communication interface 31, a memory 32, an input interface 33, an output interface 34, a positional information acquisition interface 35, and a controller 36. With respect to the configuration of each component included in the second terminal apparatus 30, the same explanation as the corresponding component included in the above described first terminal apparatus 20 applies.

When the input interface 33 detects an operation by the user as a member of staff of an operating company who requests registration of holding information, the controller 36 displays an input screen indicating items required for registration of the holding information, using the output interface 34. The items required for registration of the holding information include, for example, items of a holding area, a start date and time, an end date and time, and details of a music supply to be used. The controller 36 acquires input information regarding these items that the member of staff inputs by operating the input interface 33. The controller 36 transmits the acquired input information as the holding information to the information processing apparatus 10 via the communication interface 31 and the network 50.

In addition to the holding information, the controller 36 also transmits participant information on participants including an instructor and a student participating in a music class, to the information processing apparatus 10 via the communication interface 31 and the network 50. In this specification, “participant information” includes, for example, an address of each participant, a participation start date and time, and a participation end date and time. The participant information is acquired by the controller 36 by, for example, being transmitted from any terminal apparatus used by the participants to the second terminal apparatus 30.

The controller 36 receives, from the information processing apparatus 10 via the network 50 and the communication interface 31, pickup information for the vehicle 40 to pick up the participants of the music class, which is determined by the information processing apparatus 10 based on the participant information. In this specification, “pickup information” includes, for example, a pickup location, a pickup route, and a pickup date and time that are optimized, according to the participant information, for the vehicle 40 to pick up the participants. The controller 36 notifies the participants of the pickup information received from the information processing apparatus 10, as required. For example, the participants understand the pickup location and the pickup date and time of the vehicle 40 in which the music class is held, based on the pickup information transmitted from the second terminal apparatus 30 to any terminal apparatus used by the participants.

The controller 36 receives, from a terminal apparatus used by an instructor, for example, student evaluation information regarding playing in a music class, or maintenance person evaluation information regarding the quality of maintenance on a music supply performed by a maintenance person. The controller 36 transmits the received evaluation information as evaluation information indicating a result of an evaluation by the instructor of another from among the instructor and the student of the music class and the maintenance person, to the information processing apparatus 10 via the communication interface 31 and the network 50.

The controller 36 receives, from a terminal apparatus used by a student, for example, instructor evaluation information regarding playing instructions in a music class, or maintenance person evaluation information regarding the quality of maintenance on a music supply performed by a maintenance person. The controller 36 transmits the received evaluation information as evaluation information indicating a result of an evaluation by the student of another from among the instructor and the student of the music class and the maintenance person, to the information processing apparatus 10 via the communication interface 31 and the network 50.

The controller 36 receives, from the information processing apparatus 10 via the network 50 and the communication interface 31, for example, instructor evaluation information indicating a result of an evaluation by a maintenance person, of the quality of an evaluation comment received from an instructor. The controller 36 transmits the received evaluation information to a terminal apparatus used by the instructor, as required. For example, upon receiving instructor evaluation information indicating a result of an evaluation of the instructor by a student regarding playing instructions in the music class, from a terminal apparatus used by the student, the controller 36 may transmit the received evaluation information to the terminal apparatus used by the instructor, as required.

The controller 36 receives, from the information processing apparatus 10 via the network 50 and the communication interface 31, for example, student evaluation information indicating a result of an evaluation by a maintenance person, of the quality of an evaluation comment received from a student. The controller 36 transmits the received evaluation information to a terminal apparatus used by the student, as required. For example, upon receiving student evaluation information indicating a result of an evaluation of the student by an instructor regarding playing in the music class, from a terminal apparatus used by the instructor, the controller 36 may transmit the received evaluation information to the terminal apparatus used by the student, as required.

In the vehicle 40, for example, vehicle control based on control information received from the information processing apparatus 10 is performed. The vehicle control is, for example, automated driving control for navigating the vehicle 40 to each pickup location, at which a corresponding participant is to be picked up, according to a pickup route based on the above mentioned pickup information determined by the information processing apparatus 10, but is not limited to this. The vehicle control may be automated driving control for navigating the vehicle 40 to a delivery location for delivering a music supply which is to be used in a music class and is to be subject to maintenance, to a maintenance person, and a collection location for collecting a music supply, for which maintenance is complete, from the maintenance person, based on route information, which will be described later.

Next, the configuration of the information processing apparatus 10 included in the information processing system 1 will be primarily described. As illustrated in FIG. 2, the information processing apparatus 10 includes a communication interface 11, a memory 12, and a controller 13.

The communication interface 11 includes a communication module connected to the network 50. For example, the communication interface 11 may include a communication module compliant with mobile communication standards such as the 4G and the 5G standards. In an embodiment, the information processing apparatus 10 is connected to the network 50 via the communication interface 11. The communication interface 11 transmits and receives various information via the network 50.

The memory 12 is, for example, a semi-conductor memory, a magnetic memory, an optical memory, or the like, but is not limited to these. The memory 12 may function as, for example, a main memory, an auxiliary memory, or a cache memory. The memory 12 stores any information used in operation of the information processing apparatus 10. For example, the memory 12 may store a system program, an application program, various types of information received by the communication interface 11, and the like. Information stored in the memory 12 may be updated with, for example, information received from the network 50 via the communication interface 11.

The controller 13 includes at least one processor. The “processor” is a general purpose processor or a dedicated processor that is dedicated to specific processing in an embodiment but is not limited to these. The controller 13 is connected to each component included in the information processing apparatus 10 so as to communicate with each component, and controls operation of the entire information processing apparatus 10.

The controller 13 receives holding information on each music class to be held in the vehicle 40 from the second terminal apparatus 30 via the network 50 and the communication interface 11. The controller 13 receives maintenance information on each maintenance person who performs maintenance on a music supply to be used in a corresponding music class, from each first terminal apparatus 20 via the network 50 and the communication interface 11. The controller 13 executes matching between a music class and a maintenance person based on the holding information and the maintenance information that are received. The controller 13 determines notification information to be notified to the maintenance person according to the result of the matching. The controller 13 transmits the determined notification information to the first terminal apparatus 20 of the maintenance person related to the notification information via the communication interface 11 and the network 50.

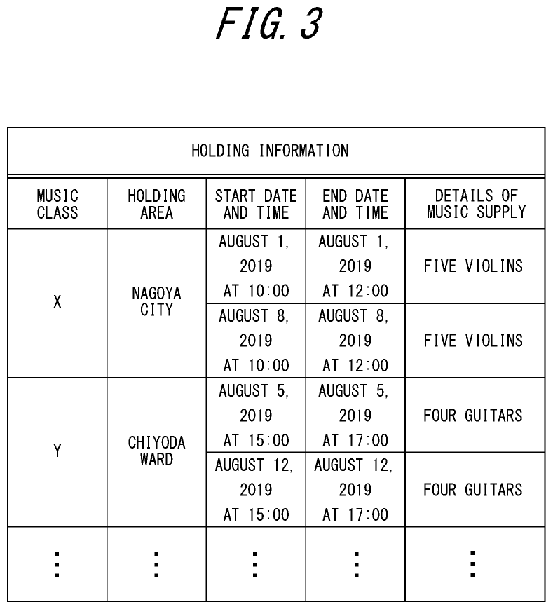

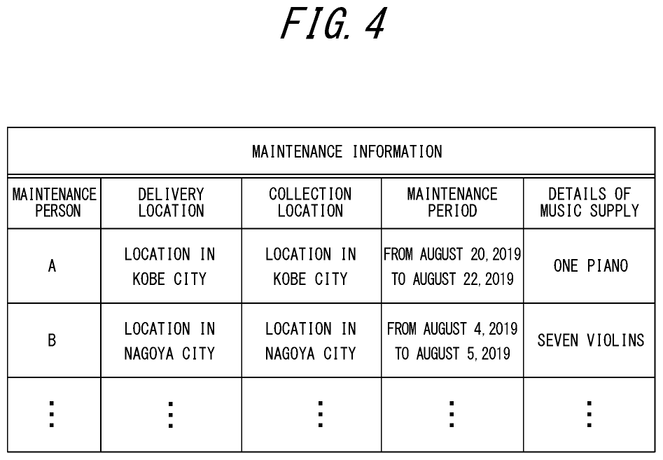

FIG. 3 is a first diagram for explaining matching between a music class and a maintenance person. FIG. 4 is a second diagram for explaining the matching between the music class and the maintenance person. Referring to FIGS. 3 and 4, examples of a matching process and a determining process for notification information executed by the controller 13 will be described in more detail.

The controller 13 acquires holding information on music class X to be held in the vehicle 40. According to the holding information on music class X, the holding area is Nagoya City. Similarly, the first start date and time, and the first end date and time are Aug. 1, 2019 at 10:00 and 12:00, respectively. The second start date and time, and the second end date and time are Aug. 8, 2019 at 10:00 and 12:00, respectively. The details of the music supplies to be used in music class X are five violins.

The controller 13 acquires holding information on music class Y to be held in the vehicle 40. According to the holding information on music class Y, the holding area is Chiyoda Ward. Similarly, the first start date and time, and the first end date and time are Aug. 5, 2019 at 15:00 and 17:00, respectively. The second start date and time, and the second end date and time are Aug. 12, 2019 at 15:00 and 17:00, respectively. The details of the music supplies to be used in music class Y are four guitars.

In addition to the holding information on music classes X and Y, the controller 13 may further acquire holding information on other music classes. The holding information is not limited to the contents illustrated in FIG. 3, and may include any content. For example, the number of types of music supplies to be used in one music class is not limited to one, and may be two or more. For example, a musical score in addition to a musical instrument, or multiple types of musical instruments may be included as the types of music supplies to be used in one music class.

The controller 13 acquires maintenance information on maintenance person A who performs maintenance on a music supply to be used in a music class. According to the maintenance information on maintenance person A, the delivery location and the collection location desired by maintenance person A is a predetermined location in Kobe City. Similarly, the maintenance period desired by maintenance person A is from Aug. 20, 2019 to Aug. 22, 2019, and the details of the music supply are one piano.

The controller 13 acquires maintenance information on maintenance person B who performs maintenance on music supplies to be used in a music class. According to the maintenance information on maintenance person B, the delivery location and the collection location desired by maintenance person B is a predetermined location in Nagoya City. Similarly, the maintenance period desired by maintenance person B is from Aug. 4, 2019 to Aug. 5, 2019, and the details of the music supplies are seven violins.

In addition to the maintenance information on maintenance persons A and B, the controller 13 may further acquire maintenance information on other maintenance persons. The maintenance information is not limited to the contents illustrated in FIG. 4, and may include any content. For example, the number of types of music supplies on which one maintenance person desires to perform maintenance is not limited to one, and may be two or more. For example, a musical score in addition to a musical instrument, or multiple types of musical instruments may be included as the types of music supplies on which one maintenance person desires to perform maintenance.

In this situation, the holding area for music class X corresponds to the delivery location and the collection location for maintenance person B. The maintenance period for maintenance person B is included between the first end date and time, and the second start date and time of music class X. Therefore, the controller 13 extracts the holding information associated with music class X and the maintenance information associated with maintenance person B, from the holding information on the music classes and the maintenance information on the maintenance persons that are acquired, thereby executing matching between music class X and maintenance person B.

According to the result of such matching, the controller 13 may determine the delivery location and the collection location for the music supplies which are subject to maintenance to be, for example, the location in Nagoya City desired by maintenance person B as the delivery location and the collection location, or the vicinity thereof. Similarly, the controller 13 may determine the delivery date and time for the music supplies to be, for example, any date and time between Aug. 1, 2019 at 12:00, which is the first end date and time of music class X, and Aug. 4, 2019, which maintenance person B desires as the start date of the maintenance period. Similarly, the controller 13 may determine the collection date and time for the music supplies to be, for example, any date and time between Aug. 5, 2019, which the maintenance person B desires as the end date of the maintenance period, and Aug. 8, 2019 at 10:00, which is the second start date and time of music class X. Similarly, the controller 13 may determine the details of the music supplies regarding the maintenance of the music supplies to be, for example, five violins, which will actually be used in music class X, out of seven violins on which maintenance person B desires to perform maintenance.

The controller 13 receives participant information on participants including an instructor and a student participating in a music class, from the second terminal apparatus 30 via the network 50 and the communication interface 11. The controller 13 determines pickup information for the vehicle 40 to pick up the participants of the music class, based on the received participant information. In addition, the controller 13 determines, as route information, routes for navigating the vehicle 40 to the location at which a music supply is to be delivered and the location at which a music supply is to be collected, the locations being included in the determined notification information. The controller 13 transmits the determined pickup information to the second terminal apparatus 30 and the vehicle 40 via the communication interface 11 and the network 50. The controller 13 transmits the determined route information along with the notification information to the vehicle 40 via the communication interface 11 and the network 50.

The controller 13 acquires evaluation information indicating a result of an evaluation by one of another from among the instructor and the student of the music class and a maintenance person. For example, the controller 13 receives instructor evaluation information or student evaluation information from the first terminal apparatus 20 of the maintenance person via the network 50 and the communication interface 11. For example, the controller 13 receives student evaluation information or maintenance person evaluation information from a terminal apparatus used by the instructor via the second terminal apparatus 30, the network 50, and the communication interface 11. For example, the controller 13 receives instructor evaluation information or maintenance person evaluation information from a terminal apparatus used by the student via the second terminal apparatus 30, the network 50, and the communication interface 11.

The controller 13 may determine, for example, a tuition fee to be paid by the student to the operating company for taking the music class, based on the acquired student evaluation information. For example, when the controller 13 determines that the evaluation rank in the acquired student evaluation information is lower than a predetermined rank, the controller 13 may determine the tuition fee to be higher than a predetermined amount. For example, when the controller 13 determines that the evaluation rank in the acquired student evaluation information is equal to or higher than the predetermined rank, the controller 13 may determine the tuition fee to be equal to or lower than the predetermined amount. Similarly, the controller 13 may determine the tuition fee to be paid by the student to the operating company, by associating the evaluation score, the evaluation comment, and the like in the acquired student evaluation information, with the tuition fee.

The controller 13 may determine, for example, a payment to be obtained by the instructor from the operating company for giving the playing instructions in the music class, based on the acquired instructor evaluation information. For example, when the controller 13 determines that an evaluation rank in the acquired instructor evaluation information is lower than a predetermined rank, the controller 13 may determine the payment to be lower than a predetermined amount. For example, when the controller 13 determines that the evaluation rank in the acquired instructor evaluation information is equal to or higher than the predetermined rank, the controller 13 may determine the payment to be equal to or higher than the predetermined amount. Similarly, the controller 13 may determine the payment to be obtained by the instructor from the operating company, by associating an evaluation score, an evaluation comment, and the like in the acquired instructor evaluation information, with the payment.

The controller 13 may determine, for example, a maintenance fee to be paid by the operating company that operates the music class to the maintenance person for the music supply, based on the acquired maintenance person evaluation information. For example, when the controller 13 determines that an evaluation rank in the acquired maintenance person evaluation information is lower than a predetermined rank, the controller 13 may determine the maintenance fee for the music supply to be lower than a predetermined amount. For example, when the controller 13 determines that the evaluation rank in the acquired maintenance person evaluation information is equal to or higher than the predetermined rank, the controller 13 may determine the maintenance fee for the music supply to be equal to or higher than the predetermined amount. Similarly, the controller 13 may determine the maintenance fee for the music supply to be paid by the operating company to the maintenance person, by associating an evaluation score, an evaluation comment, and the like in the acquired maintenance person evaluation information, with the maintenance fee for the music supply.

The controller 13 transmits all of the above mentioned determination information determined based on the evaluation information, to the second terminal apparatus 30 via the communication interface 11 and the network 50. In addition, the controller 13 transmits information regarding the maintenance fee for the music supply to be paid by the operating company to the maintenance person, which is determined based on the maintenance person evaluation information, to the first terminal apparatus 20 via the communication interface 11 and the network 50.

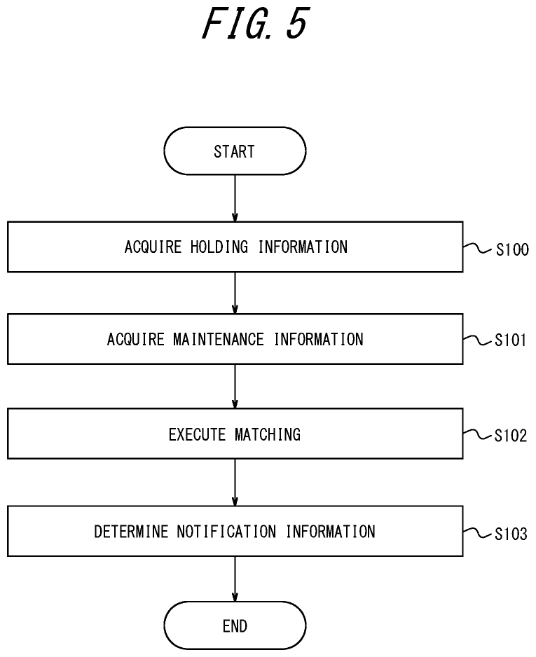

Next, an information processing method executed by the controller 13 of the information processing apparatus 10 according to an embodiment will be described, referring to FIGS. 5 to 8. FIG. 5 is a flowchart for explaining a first example of the information processing method executed by the information processing apparatus 10 in FIG. 1.

In step S100, the controller 13 acquires holding information on each music class to be held in the vehicle 40.

In step S101, the controller 13 acquires maintenance information on each maintenance person who performs maintenance on a music supply to be used in a corresponding music class.

In step S102, the controller 13 executes matching between a music class and a maintenance person based on the holding information acquired in step S100 and the maintenance information acquired in step S101.

In step S103, the controller 13 determines notification information to be notified to the maintenance person according to the result of the matching in step S102.

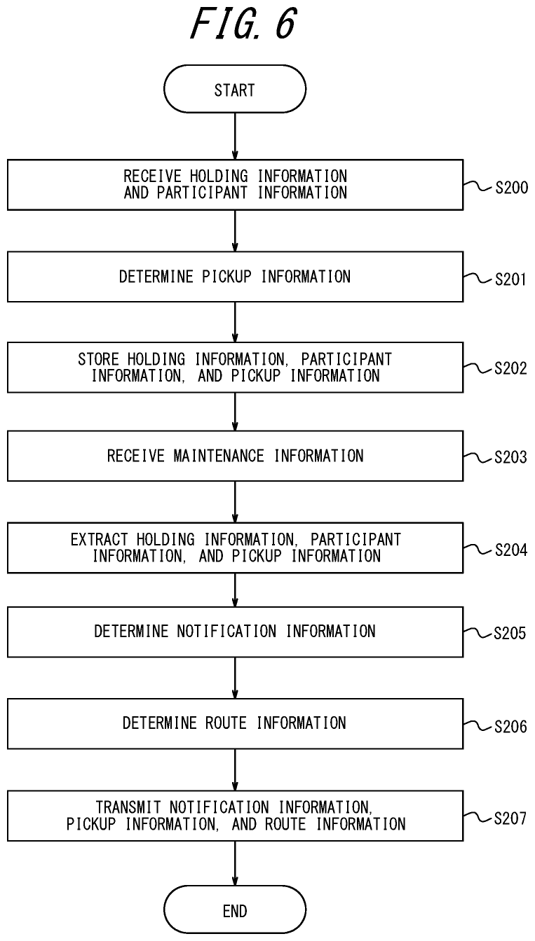

FIG. 6 is a flowchart for explaining a second example of the information processing method executed by the information processing apparatus 10 in FIG. 1. The flowchart given in FIG. 6 illustrates the control flow of the flowchart given in FIG. 5 in more detail. The flowchart in FIG. 6 illustrates a control flow performed when execution of the matching between the music class and the maintenance person is triggered by transmittal of the maintenance information to the information processing apparatus 10 by the maintenance person using the first terminal apparatus 20.

In step S200, the controller 13 receives the holding information on each music class to be held in the vehicle 40 and participant information related to the holding information, from the second terminal apparatus 30 via the network 50 and the communication interface 11.

In step S201, the controller 13 determines pickup information for the vehicle 40 to pick up participants including an instructor and a student of each music class, based on the participant information on the participants.

In step S202, the controller 13 stores the holding information and the participant information received in step S200 and the pickup information determined in step S201, in the memory 12.

In step S203, the controller 13 receives the maintenance information from the first terminal apparatus 20 of the maintenance person via the network 50 and the communication interface 11.

In step S204, the controller 13 executes the matching by extracting a series of information including the holding information, the participant information, and the pickup information corresponding to the maintenance information received in step S203, from the series of information associated with the music classes.

In step S205, the controller 13 determines the notification information to be notified to the maintenance person according to the result of the matching in step S204.

In step S206, the controller 13 determines, as route information, routes for navigating the vehicle 40 to the location at which the music supply is to be delivered and the location at which the music supply is to be collected, the locations being included in the notification information determined in step S205,

In step S207, the controller 13 transmits the notification information determined in step S205 to the first terminal apparatus 20 and the vehicle 40 via the communication interface 11 and the network 50. The controller 13 transmits the pickup information determined in step S201 to the second terminal apparatus 30 and the vehicle 40 via the communication interface 11 and the network 50. The controller 13 transmits the route information determined in step S206 to the vehicle 40 via the communication interface 11 and the network 50.

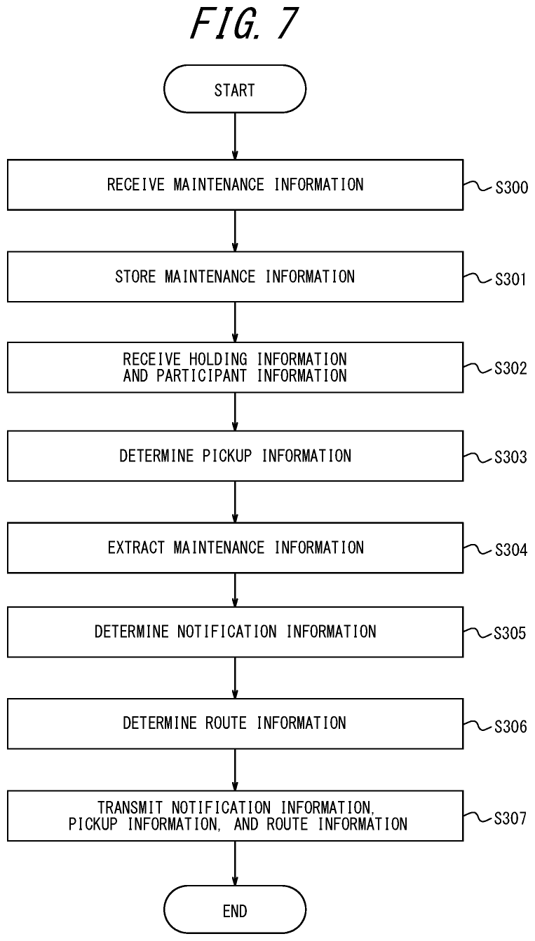

FIG. 7 is a flowchart for explaining a third example of the information processing method executed by the information processing apparatus 10 in FIG. 1. The flowchart given in FIG. 7 illustrates the control flow of the flowchart given in FIG. 5 in more detail. The flowchart in FIG. 7 illustrates a control flow performed when execution of the matching between the music class and the maintenance person is triggered by transmittal of the holding information to the information processing apparatus 10 by a member of staff of an operating company that operates the music class using the second terminal apparatus 30.

In step S300, the controller 13 receives the maintenance information on each maintenance person who performs maintenance on the music supply to be used in a corresponding music class, from the first terminal apparatus 20 of each maintenance person via the network 50 and the communication interface 11.

In step S301, the controller 13 stores the maintenance information received in step S300 in the memory 12.

In step S302, the controller 13 receives the holding information on a music class to be held in the vehicle 40 and participant information related to the holding information, from the second terminal apparatus 30 via the network 50 and the communication interface 11.

In step S303, the controller 13 determines pickup information for the vehicle 40 to pick up participants including an instructor and a student of the music class, based on the participant information on the participants.

In step S304, the controller 13 executes the matching by extracting the maintenance information corresponding to the holding information and the participant information related to the holding information that are received in step S302, from the maintenance information associated with each maintenance person.

In step S305, the controller 13 determines the notification information to be notified to a maintenance person according to the result of matching in step S304.

In step S306, the controller 13 determines, as route information, routes for navigating the vehicle 40 to the location at which the music supply is to be delivered and the location at which the music supply is to be collected, the locations being included in the notification information determined in step S305.

In step S307, the controller 13 transmits the notification information determined in step S305 to the first terminal apparatus 20 and the vehicle 40 via the communication interface 11 and the network 50. The controller 13 transmits the pickup information determined in the step S303 to the second terminal apparatus 30 and the vehicle 40 via the communication interface 11 and the network 50. The controller 13 transmits the route information determined in step S306 to the vehicle 40 via the communication interface 11 and the network 50.

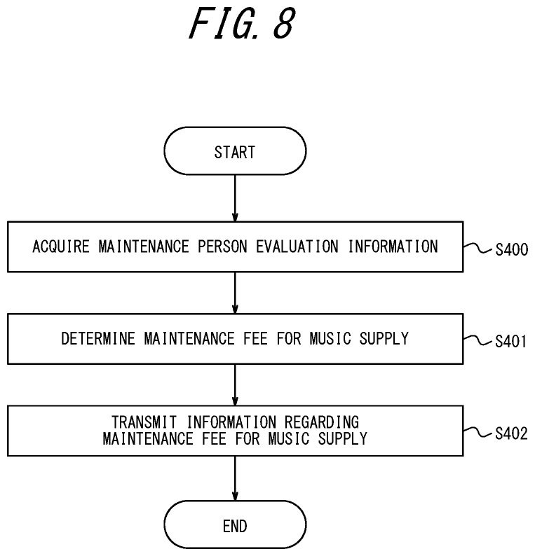

FIG. 8 is a flowchart for explaining a fourth example of the information processing method executed by the information processing apparatus 10 in FIG. 1. The flowchart given in FIG. 8 illustrates a control flow that is executed when the information processing apparatus 10 receives evaluation information indicating a result of an evaluation of the maintenance person by the instructor or the student of the music class from the second terminal apparatus 30 via the network 50 and the communication interface 11, for example, after the music class has been held.

In step S400, the controller 13 acquires the evaluation information indicating the result of the evaluation of the maintenance person by the instructor or the student of the music class.

In step S401, the controller 13 determines a maintenance fee to be paid by the operating company that operates the music class to the maintenance person for the music supply based on the maintenance person evaluation information acquired in step S400.

In step S402, the controller 13 transmits information regarding the maintenance fee for the music supply determined in step S401 to the first terminal apparatus 20 and the second terminal apparatus 30 via the communication interface 11 and the network 50. The first terminal apparatus 20 receives the information regarding the maintenance fee for the music supply from the information processing apparatus 10 via the network 50 and the communication interface 21. The second terminal apparatus 30 receives the information regarding the maintenance fee for the music supply from the information processing apparatus 10 via the network 50 and the communication interface 31.

FIG. 8 illustrates a control flow of the information processing apparatus 10 relating to the maintenance fee for the music supply in the above described determination information that is determined based on the evaluation information. A similar control flow applies to other determination information. In this case, the controller 36 of the second terminal apparatus 30 may transmit other determination information received from the information processing apparatus 10 to a terminal apparatus used by the instructor and/or a terminal apparatus used by the student, as required.

According to the above mentioned embodiment, it is possible to perform effective matching between a music class and a maintenance person. For example, since the vehicle 40 is used for holding a music class and delivering and collecting a music supply, the delivery location and the delivery date and time at which the music supply is to be delivered, and the collection location and the collection date and time at which the music supply is to be collected can be easily adjusted depending on the moving time and the moving place of the vehicle 40. That is, the limitations on the delivery location and the delivery date and time for delivering the music supply to a maintenance person, and the collection location and the collection date and time for collecting the music supply from the maintenance person are sufficiently relaxed, and thus the potential for matching between the music class and the maintenance person is improved. As a result, it is possible to effectively utilize a maintenance period desired by the maintenance person to receive maintenance of the music supply to be used in the music class. In this way, the service regarding the music class and the service regarding maintenance of the music supply are successively associated, thereby enabling the operating company to effectively utilize maintenance of the music supply. Therefore, the operating company does not need to perform maintenance on the music supply by itself, and the burden which accompanies maintenance of the music supply can be reduced. By the above, the operating company can perform operation of the music class smoothly.

As in the control flow illustrated in FIG. 6, the execution, by the information processing apparatus 10, of the matching between the music class and the maintenance person is triggered by transmittal of the maintenance information to the information processing apparatus 10 by the maintenance person using the first terminal apparatus 20, thereby selecting in real time the most appropriate music class in accordance with the maintenance information on the maintenance person from the plurality of music classes stored in the information processing apparatus 10. For example, at the point when the maintenance person can secure a maintenance period for performing maintenance on music supplies, the maintenance person can search on demand for the most appropriate music class in accordance with the maintenance information. Therefore, the maintenance person can effectively utilize the maintenance period secured by him/herself. In addition, the convenience for the maintenance person who uses the information processing system 1 which includes the information processing apparatus 10 is improved. Further, the maintenance fee for the music supply is paid by the operating company that operates the music class, to thereby improve the profit for the maintenance person obtained by maintenance of the music supply. By the above, satisfaction of the maintenance person is improved, and the mechanism for performing maintenance on the music supply by the maintenance person becomes effective.

As in the control flow of FIG. 7, the execution, by the information processing apparatus 10, of the matching between the music class and the maintenance person is triggered by transmittal of the holding information to the information processing apparatus 10 by the member of staff of the operating company that operates the music class using the second terminal apparatus 30, thereby selecting in real time the most appropriate maintenance person in accordance with the holding information on the music class from the plurality of maintenance persons stored in the information processing apparatus 10. Therefore, the convenience for the operating company that uses the information processing system 1 which includes the information processing apparatus 10 is improved. The operating company can find with more certainty a maintenance person who is able to perform maintenance on a music supply to be used in a music class, and can run the music class smoothly.

By acquiring the evaluation information indicating the result of the evaluation by one of another from among the instructor and the student of the music class and the maintenance person, the information processing apparatus 10 can determine various information related to the evaluation information for the instructor, the student, and the maintenance person. Utilizing the various determined information in the service regarding the music class and the service regarding the maintenance of the music supply improves the attractiveness of these services. Thus, the frequency of use of these services by the instructor, the student, and the maintenance person is increased. As a result, the profit for the operating company obtained by operation of the music class and the profit for the maintenance person obtained by the maintenance of music supply are improved.

The information processing apparatus 10 determines the tuition fee to be paid by the student to the operating company for taking the music class, based on the acquired student evaluation information, thereby enabling the operating company, which receives notification of the determined tuition fee, to present to the student, the tuition fee most appropriate for the playing level of the student. The student who takes the music class also attempts to improve his/her playing level in order to lower the tuition fee, and thus his/her motivation for playing is increased. Therefore, the attractiveness of the service regarding the music class is improved, and the frequency of use of the service by the student is increased. In addition, the student attempts to seriously give an evaluation comment for the maintenance person regarding the music supply, on which maintenance has been performed, in order to lower the tuition fee. Thus, the quality of the evaluation comment to be made is improved. As a result, the service regarding a series of music supply maintenance and the service regarding the music class become more attractive, and the frequency of use of these services by the instructor, the student, and the maintenance person is increased.

The information processing apparatus 10 determines the payment to be obtained by the instructor from the operating company for giving the playing instructions in the music class, based on the acquired instructor evaluation information, thereby enabling the operating company, which receives notification of the determined payment, to pay to the instructor, the payment most appropriate for the instruction level of the instructor. The instructor who gives the playing instructions in the music class also attempts to improve his/her instruction level in order to raise the payment, and thus his/her motivation for giving the playing instructions is increased. Therefore, the attractiveness of the service regarding the music class is improved, and the frequency of use of the service by the instructor is increased. In addition, the instructor attempts to seriously give an evaluation comment for the maintenance person regarding the music supply, on which maintenance has been performed, in order to raise the payment. Thus, the quality of the evaluation comment to be made is improved. As a result, the service regarding a series of music supply maintenance and the service regarding the music class become more attractive, and the frequency of use of these services by the instructor, the student, and the maintenance person is increased.

The information processing apparatus 10 determines the maintenance fee to be paid by the operating company that operates the music class to the maintenance person for the music supply, based on the acquired maintenance person evaluation information, thereby enabling the operating company, which receives notification of the determined maintenance fee for the music supply, to present to the maintenance person, for example, the maintenance fee most appropriate for the quality of maintenance of the music supply provided by the maintenance person. The maintenance person who performs maintenance on the music supply also attempts to provide a higher quality maintenance of the music supply in order to raise the maintenance fee. Thus, the quality of maintenance of the music supply to be used in the music class is improved. As a result, the service regarding a series of music supply maintenance and the service regarding the music class become more attractive, and the frequency of use of these services by the instructor, the student, and the maintenance person is increased.

The information processing apparatus 10 determines the pickup information based on the participant information, thereby enabling the vehicle 40 to pick up the instructor and student at the most appropriate times and places via the most appropriate route, for example, with automated driving. In addition, the information processing apparatus 10 determines the routes for navigating the vehicle 40 to the determined location at which the music supply is to be delivered and the determined location at which the music supply is to be collected, thereby enabling the vehicle 40 to move to the location at which the music supply is to be delivered and the location at which the music supply is to be collected via the most appropriate route, for example, with automated driving.

The music class is held in the vehicle 40, thereby ensuring the privacy of the participants participating in the music classes. Thus, the reticence of the participants to participate in the music class is reduced. The music class is held in the vehicle 40, thereby enabling reduction of noise emitted to the surroundings of the vehicle 40 in which the music class is held.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each configuration, each step, or the like, may be rearranged without logical inconsistency, and a plurality of configurations, steps, or the like can be combined into one, or divided.

For example, in the embodiment described above, one or some processing operations executed in the information processing apparatus 10 may be executed in the first terminal apparatus 20 and/or the second terminal apparatus 30. At least one or some processing operations executed in the first terminal apparatus 20 and/or the second terminal apparatus 30 may be executed in the information processing apparatus 10.

For example, a configuration in which a general purpose electronic device such as a smartphone, a computer, or the like may be caused to function as the information processing apparatus 10 according to the embodiment described above is possible. Specifically, a program in which processes for realizing the functions of the information processing apparatus 10 or the like according to the embodiment are written may be stored in a memory of the electronic device, and the program may be read and executed by a processor of the electronic device. Accordingly, the disclosure according to an embodiment can also be implemented as a program executable by a processor. Alternatively, the disclosure according to an embodiment can also be implemented as a non-transitory computer readable medium storing a program executable by a single processor or a plurality of processors to cause the information processing apparatus 10, the first terminal apparatus 20, or the like according to the embodiment to execute the functions. It is to be understood that these are also included within the scope of the present disclosure.

For example, in the embodiment described above, the vehicle 40 has been described as an automated driving vehicle, but is not limited thereto. The vehicle 40 may not be an automated driving vehicle. In a vehicle 40, which is not an automated driving vehicle, routes based on the pickup information and the route information that are received may be output to the driver, and driving along each route may be assisted.

For example, the information processing apparatus 10 described in the above embodiment may be mounted in the vehicle 40. In this case, the information processing apparatus 10 may directly perform information communication with the vehicle 40 without using the network 50. The information processing system 1 may not include the first terminal apparatus 20 and the second terminal apparatus 30, and the information processing apparatus 10 mounted in the vehicle 40 may execute the above described acquisition and notification of the information using any input interface and output interface provided in the vehicle 40. An electronic control unit (ECU) mounted in the vehicle 40 may function as the controller 13.

For example, in the embodiment described above, the music class has been described as being hosted by the operating company, but is not limited thereto. The music class may be hosted by at least one of the participants including the instructor and the student participating in the music class. In this case, at least one of the participants including the instructor and the student may provide the holding information on each music class to be held in the vehicle 40, from a terminal apparatus used by the at least one participant to the information processing apparatus 10. That is, the second terminal apparatus 30 may be a terminal apparatus used by a participant. In this case, the second terminal apparatus 30 serving as the terminal apparatus used by the participant may acquire the address of the participant as the participant information from the input interface 33, and transmit the participant information to the information processing apparatus 10 via the communication interface 31 and the network 50. The second terminal apparatus 30 is not limited to this, and may transmit the positional information for the second terminal apparatus 30 acquired by the positional information acquisition interface 35 as the participant information to the information processing apparatus 10. The information processing apparatus 10 may determine the pickup information for the vehicle 40 to pick up the participants of the music class, based on the received positional information for the second terminal apparatus 30.

For example, in the embodiment described above, the first terminal apparatus 20 has been described as acquiring the delivery location and the collection location desired by the maintenance person as the maintenance information from the input interface 23, and transmitting the maintenance information to the information processing apparatus 10 via the communication interface 21 and the network 50, but is not limited thereto. The first terminal apparatus 20 may transmit the positional information for the first terminal apparatus 20 acquired by the positional information acquisition interface 25 as the maintenance information to the information processing apparatus 10. The information processing apparatus 10 may determine the notification information including the location at which the music supply is to be delivered and the location at which the music supply is to be collected, based on the received positional information for the first terminal apparatus 20.

For example, in the embodiment described above, the music class may be held after the information processing apparatus 10 executes the matching and the maintenance of the music supply is completed, or the information processing apparatus 10 may execute the matching in real time while the music class is being held, and the music class may be held while maintenance on the music supply is being performed.

For example, in the embodiment described above, the information processing apparatus 10 has been described as executing the matching by extracting specific holding information and specific maintenance information, but is not limited thereto. For example, in a case in which there is a plurality of candidate music classes for the matching, the information processing apparatus 10 may transmit candidate information as a list to the first terminal apparatus 20 of the maintenance person. The maintenance person may select the holding information on a specific music class which the maintenance person ultimately desires, while checking a candidate list displayed on the output interface 24 of the first terminal apparatus 20.

For example, in the embodiment described above, the information processing apparatus 10 has been described as executing the matching by extracting specific holding information and specific maintenance information, but is not limited thereto. For example, in a case in which there is a plurality of candidate maintenance persons for the matching, the information processing apparatus 10 may transmit candidate information as a list to the second terminal apparatus 30. The member of staff of the operating company may select the maintenance information on a specific maintenance person whom the member of staff ultimately desires, while checking a candidate list displayed on the output interface 34 of the second terminal apparatus 30. Similarly, the instructor or the student of the music class may select the maintenance information on a specific maintenance person whom the instructor or the student ultimately desires, based on the candidate information transmitted from the second terminal apparatus 30 to his/her terminal apparatus.

For example, in the embodiment described above, execution of matching between a music class and a maintenance person has been described as being triggered by receipt of maintenance information by the information processing apparatus 10 from the first terminal apparatus 20, or by receipt of holding information by the information processing apparatus 10 from the second terminal apparatus 30, but is not limited thereto. For example, the matching between the music class and the maintenance person may be executed based on details of a music supply, including a usage period that has elapsed since previous maintenance, a total usage period, or a usage frequency.

For example, the information processing apparatus 10 may execute the matching between the music class and the maintenance person, upon determining, with respect to a predetermined music supply to be used in the music class, that the usage period that has elapsed since previous maintenance has exceeded a predetermined period. For example, the information processing apparatus 10 may execute the matching between the music class and the maintenance person, upon determining, with respect to a predetermined music supply to be used in the music class, that the total usage period has exceeded a predetermined period. For example, the information processing apparatus 10 may execute the matching between the music class and the maintenance person, upon determining, with respect to a predetermined music supply to be used in the music class, that the usage frequency has exceeded the predetermined number of times.

1. An information processing apparatus comprising a controller configured to:
acquire holding information on a music class to be held in a vehicle and maintenance information on a maintenance person who performs maintenance on a music supply to be used in the music class;
execute matching between the music class and the maintenance person based on the holding information and the maintenance information that are acquired; and
determine notification information to be notified to the maintenance person according to a result of the matching.

2. The information processing apparatus according to claim 1, wherein, upon receiving, via a communication interface, the maintenance information from a first terminal apparatus of the maintenance person, the controller executes the matching by extracting the holding information corresponding to the received maintenance information, and transmits, via the communication interface, the determined notification information to the first terminal apparatus.

3. The information processing apparatus according to claim 1, wherein, upon receiving, via a communication interface, the holding information from a second terminal apparatus which is separate from a first terminal apparatus of the maintenance person, the controller executes the matching by extracting the maintenance information corresponding to the received holding information, and transmits, via the communication interface, the determined notification information to the first terminal apparatus.

4. The information processing apparatus according to claim 1, wherein the controller is configured to acquire evaluation information indicating a result of an evaluation by one of another from among an instructor and a student of the music class and the maintenance person.

5. The information processing apparatus according to claim 4, wherein
the evaluation information indicates a result of an evaluation of the maintenance person by the instructor or the student, and
the controller is configured to determine a maintenance fee to be paid to the maintenance person for the music supply, based on the acquired evaluation information for the maintenance person.

6. The information processing apparatus according to claim 1, wherein the controller is configured to determine pickup information for the vehicle to pick up participants including an instructor and a student of the music class, based on participant information on the participants, and to determine routes for navigating the vehicle to a location at which the music supply is to be delivered and a location at which the music supply is to be collected, the locations being included in the determined notification information.

7. The information processing apparatus according to claim 1, wherein the notification information includes a delivery location together with a delivery date and time for the vehicle to deliver the music supply to the maintenance person, and a collection location together with a collection date and time for the vehicle to collect the music supply, for which maintenance is complete, from the maintenance person.

8. An information processing system comprising:
the information processing apparatus according to claim 1;
a first terminal apparatus of the maintenance person, the first terminal apparatus being configured to transmit the maintenance information to the information processing apparatus; and
a second terminal apparatus which is separate from the first terminal apparatus of the maintenance person, the second terminal apparatus being configured to transmit the holding information to the information processing apparatus.

9. A non-transitory computer readable medium storing a program executable by one or more processors to cause an information processing apparatus to execute functions, the functions comprising:
acquiring holding information on a music class to be held in a vehicle;
acquiring maintenance information on a maintenance person who performs maintenance on a music supply to be used in the music class;
executing matching between the music class and the maintenance person based on the holding information and the maintenance information that are acquired; and
determining notification information to be notified to the maintenance person according to a result of the matching.

10. The non-transitory computer readable medium according to claim 9, wherein
the acquiring of the maintenance information comprises receiving the maintenance information from a first terminal apparatus of the maintenance person, and
the executing of the matching comprises executing the matching by extracting the holding information corresponding to the received maintenance information,
the functions further comprising transmitting the determined notification information to the first terminal apparatus.

11. The non-transitory computer readable medium according to claim 9, wherein
the acquiring of the holding information comprises receiving the holding information from a second terminal apparatus which is separate from a first terminal apparatus of the maintenance person, and
the executing of the matching comprises executing the matching by extracting the maintenance information corresponding to the received holding information,
the functions further comprising transmitting the determined notification information to the first terminal apparatus.

12. The non-transitory computer readable medium according to claim 9, the functions further comprising acquiring evaluation information indicating a result of an evaluation by one of another from among an instructor and a student of the music class and the maintenance person.

13. The non-transitory computer readable medium according to claim 12, wherein the evaluation information indicates a result of an evaluation of the maintenance person by the instructor or the student,
the functions further comprising determining a maintenance fee to be paid to the maintenance person for the music supply, based on the acquired evaluation information for the maintenance person.

14. The non-transitory computer readable medium according to claim 9, the functions further comprising:
determining pickup information for the vehicle to pick up participants including an instructor and a student of the music class, based on participant information on the participants; and
determining routes for navigating the vehicle to a location at which the music supply is to be delivered and a location at which the music supply is to be collected, the locations being included in the determined notification information.

15. A non-transitory computer readable medium storing a program executable by one or more processors to cause a terminal apparatus of a maintenance person who performs maintenance on a music supply to be used in a music class, to execute functions, the functions comprising:
transmitting maintenance information on the maintenance person who performs maintenance on the music supply to be used in the music class to be held in a vehicle, to an information processing apparatus; and
receiving notification information determined by the information processing apparatus according to a result of matching between the music class and the maintenance person executed by the information processing apparatus based on holding information on the music class and the maintenance information that are acquired by the information processing apparatus.

16. The non-transitory computer readable medium according to claim 15, wherein, when the transmitted maintenance information is received by the information processing apparatus, the holding information corresponding to the received maintenance information is extracted by the information processing apparatus to thereby execute the matching, and the notification information determined by the information processing apparatus is received.

17. The non-transitory computer readable medium according to claim 15, wherein, when the holding information is received by the information processing apparatus from a terminal apparatus which is separate from the terminal apparatus of the maintenance person, the maintenance information corresponding to the received holding information is extracted by the information processing apparatus to thereby execute the matching, and the notification information determined by the information processing apparatus is received.

18. The non-transitory computer readable medium according to claim 15, the functions further comprising receiving evaluation information acquired by the information processing apparatus, the evaluation information indicating a result of an evaluation of the maintenance person by an instructor or a student of the music class.

19. The non-transitory computer readable medium according to claim 18, the functions further comprising receiving information regarding a maintenance fee to be paid to the maintenance person for the music supply, which is determined by the information processing apparatus based on the acquired evaluation information for the maintenance person.

20. The non-transitory computer readable medium according to claim 15, wherein the notification information includes a location at which the music supply is to be delivered and a location at which the music supply is to be collected, the locations being located on routes for navigating the vehicle and being determined by the information processing apparatus.
